(19) United States
(12) Patent Application Publication
(10) Pub. No.: US 2026/0102830 A1
(43) Pub. Date: Apr. 16, 2026

(54) Tool for enabling use of digital angle gauge with bandsaw blade

(71) Applicant: Andrew J. Klein, Parker, CO (US)

(72) Inventor: Andrew J. Klein, Parker, CO (US)

(21) Appl. No.: 19/357,467

(22) Filed: Oct. 14, 2025

Related U.S. Application Data
(60) Provisional application No. 63/706,896, filed on Oct. 14, 2024.

(51) Int. Cl. B23D 59/00

(52) U.S. Cl. CPC B23D 59/002

(57) ABSTRACT

A tool designed to enable accurate use of a digital angle gauge with a bandsaw blade to square the blade to a table of the bandsaw. The tool securely attaches to the bandsaw blade using a linear array of shallow-depth-of-field magnets. The tool features a precisely machined platform at a 90-degree angle from the magnet reference surface to support the digital angle gauge. A counterweight is incorporated to align the combined center of gravity of the tool and gauge with the plane of the bandsaw blade, preventing blade deflection and ensuring precise angle measurements when squaring the bandsaw table.

### CROSS REFERENCE TO RELATED APPLICATION

This application claims priority to and the benefit of U.S. Provisional Application Ser. No. 63/706,896, filed on Oct. 14, 2024, the contents of which are incorporated herein in their entirety.

### BACKGROUND

This invention relates to woodworking tools, specifically to devices used for accurately setting the angle of a bandsaw table relative to the bandsaw blade.

Digital angle gauges are commonly used in woodworking to measure and set precise angles. These gauges are typically cube-shaped devices with magnets on their sides, allowing them to attach to metallic surfaces like table saw blades. However, when used with bandsaw blades, especially thin ones, existing digital angle gauges face significant challenges. The magnets on the gauges are often too weak to securely attach to thin bandsaw blades. Even when they can attach, the weight of the gauge can cause the blade to deflect, leading to inaccurate angle measurements.

### SUMMARY

An aspect of the present disclosure relates to a tool designed to enable woodworkers to use a digital angle gauge to square up a bandsaw table relative to the bandsaw blade accurately. The tool features a linear array of shallow-depth-of-field magnets that attach securely to even the thinnest bandsaw blades. Extending from the body of the tool is a precisely machined platform set at a 90-degree angle from the magnet reference surface. This platform is configured to support a digital angle gauge. A counterweight is incorporated into the platform so that when the digital angle gauge is placed on the platform, the combined center of gravity of the tool and gauge aligns with the bandsaw blade. This design prevents blade deflection caused by the weight of the gauge, ensuring accurate angle measurements allowing for easy adjustable of a table angle with respect to the bandsaw.

An aspect of the present disclosure relates to a tool for enabling the use of a digital angle gauge with a bandsaw blade, comprising a main body comprising a magnet reference surface and configured to attach securely to a bandsaw blade; a platform extending perpendicularly from the main body at a 90-degree angle relative to the magnet reference surface and comprising a surface configured to support a digital angle gauge thereon; and a counterweight, wherein the counterweight is configured such that a combined center of gravity of the tool and the digital angle gauge supported thereon aligns with a plane of the bandsaw blade when the tool is used, thereby preventing deflection of the bandsaw blade under a weight of the digital angle gauge.

In one or more embodiments, the magnet reference surface comprises an array of magnets. The magnets are neodymium magnets arranged linearly along the main body to maximize magnetic engagement with thin bandsaw blades.

In one or more embodiments, the platform extends perpendicularly from the main body at exactly a 90-degree angle.

In one or more embodiments, the counterweight is integrated into a body of the platform.

In one or more embodiments, the platform is supported by a platform body which is secured to the main body and wherein the counterweight is provided in or by the main body of the platform.

In one or more embodiments, the main body and platform are constructed from lightweight, rigid materials selected from the group consisting of aluminum, magnesium, and composite alloys.

In one or more embodiments, the counterweight is made from a dense material selected from the group consisting of steel, tungsten, and lead to achieve the necessary mass in a compact form.

In one or more embodiments, the platform includes a non-slip surface or material to prevent the digital angle gauge from sliding during use.

In one or more embodiments, the tool is further configured to be easily attachable and detachable from the bandsaw blade without the need for additional tools or clamps.

Another aspect of the present disclosure relates to a method of squaring a bandsaw blade to a bandsaw table, comprising magnetically coupling a main body having a platform surface positioned at a 90 angle thereto, to a bandsaw blade; positioning a digital angle gauge on the platform surface; fine tuning an angle of the bandsaw table according to one or more readings from the digital angle gauge; and removing the digital angle gauge and main body having the platform from the bandsaw blade.

The method further comprises providing a counterweight with the main body having the platform and incorporating the counterweight by aligning the combined center of gravity of the main body having the platform and the digital angle gauge with a plane of the bandsaw blade.

### BRIEF DESCRIPTION OF THE DRAWINGS

FIG. 1 is a front perspective view of a blade square pitch tool for attachment to a bandsaw blade and configured for use with a digital angle gauge supported on the platform.

FIG. 2 is a rear perspective view thereof.

FIG. 3 is a side perspective view thereof.

FIG. 4 is a front perspective view of the tool securely attached to a bandsaw blade of a bandsaw.

FIG. 5 is an image of the tool in use with a digital angle gauge.

FIG. 6 illustrates an alternative embodiment of the tool.

### DETAILED DESCRIPTION

Described herein is a device which addresses the limitations of the prior art devices by providing a specialized tool that allows a digital angle gauge to be used effectively with bandsaw blades without causing deflection or measurement errors.

A blade square pitch is a tool which attaches directly to a bandsaw blade and provides a surface for supporting a digital angle gauge thereon to allow the user to easily and quickly square up the table of the band saw to the blade. The tool has a vertical surface which comprises one or more magnets which secure the device directly to and along a length of the bandsaw blade. The tool also has a horizontal surface which may be provided with an integrated counterweight or in alternative embodiments provided with a surface for supporting a counterweight such that the horizontal surface serves as a platform for supporting a digital gauge thereon. This allows the user to fine tune the table angle while the digital gauge guides. The tool, when coupled to the bandsaw blade increases the ease with which the bandsaw blade and table are squared with respect to one another and eliminates the need to make adjustments to the table visually inspecting the gap between the table and the blade using a square.

The blade square pitch tool according to one or more embodiments described herein is designed to enable accurate use of a digital angle gauge with a bandsaw blade to square the blade to a table of the bandsaw. The tool is configured with integrated magnets to securely attach a length of the tool to the bandsaw blade. For example, the tool may incorporate a linear array of shallow-depth-of-field magnets along its main body, also referred to the as magnet reference surface. The tool may then feature a precisely machined platform positioned at a 90-degree angle from the magnet reference surface to support the digital angle gauge thereon. A counterweight is incorporated into the tool, to align the combined center of gravity of the tool and a gauge supported thereon with the plane of the bandsaw blade. This tool design thus prevents blade deflection and ensures the precise angle measurements when squaring the bandsaw table with respect to the blade and eliminating the need for visualizing the gap between the table and the blade.

In one or more embodiments, the magnets may be shallow-depth-of-field magnets. Such magnets have strong magnetic pull and shallow fields, allowing them to attach securely to even thin bandsaw blades without affecting nearby metallic components.

In one or more embodiments, the platform and main body of the tool are machined with high precision to ensure that the platform is secured to the main body exactly at a 90-degree angle relative to the magnet reference surface. This precise angle is critical for accurate angle measurements when squaring the bandsaw table.

In one or more embodiments, the mass and position of the counterweight incorporated into or otherwise supported by the platform are calculated so that the combined center of gravity of the tool and the digital angle gauge aligns exactly with the plane of the bandsaw blade. This alignment prevents any torque or bending moment that would cause the blade to deflect under the weight of the digital angle gauge.

In one or more embodiments, the tool including the main body and platform are constructed from a rigid, lightweight material such as aluminum or a composite alloy to minimize the overall weight while maintaining structural integrity. The counterweight may comprise the same material or be comprised of a denser material like steel or tungsten, in order to achieve the necessary mass in a compact form.

In one or more embodiments, the platform includes a non-slip surface or material to prevent the digital angle gauge from sliding during use.

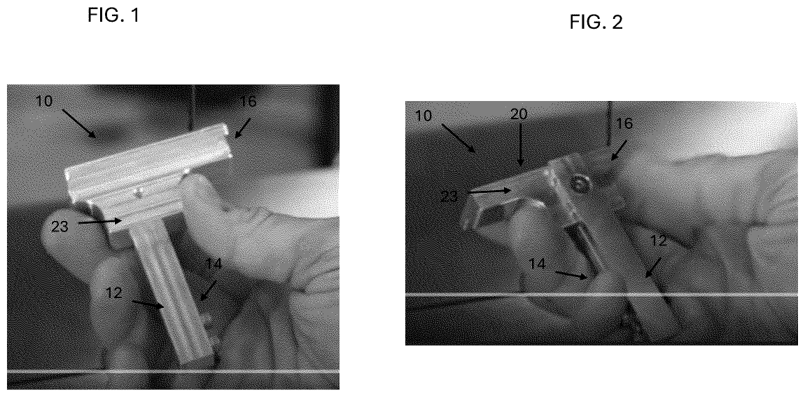

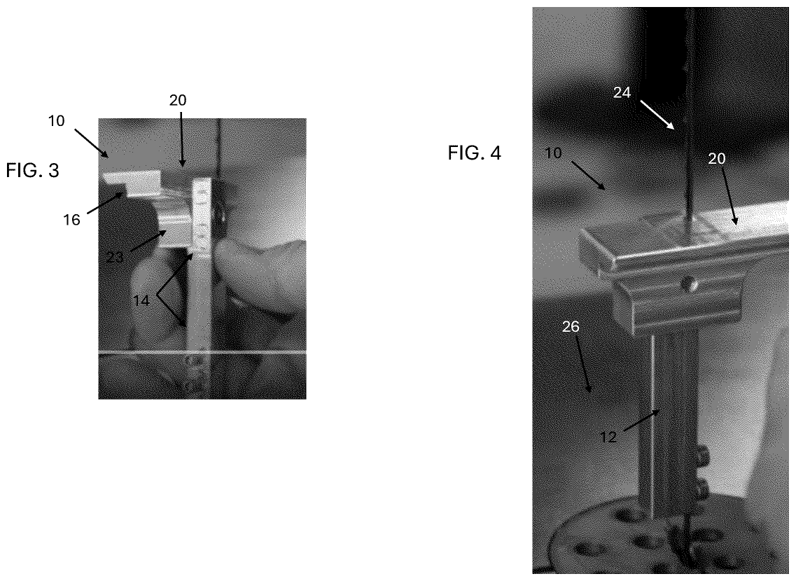

A blade square pitch tool 10 is illustrated in FIGS. 1-3. The tool 10 comprises a main body 12 which supports a linear array of magnets 14 thereon or therein. A platform 16 is secured to the main body 12 and oriented at 90 degrees with respect to the main body 12. The platform 16 has a length 18 which provides an upper surface 20 which supports a digital angle gauge 22 thereon and a counterweight 23 incorporated.

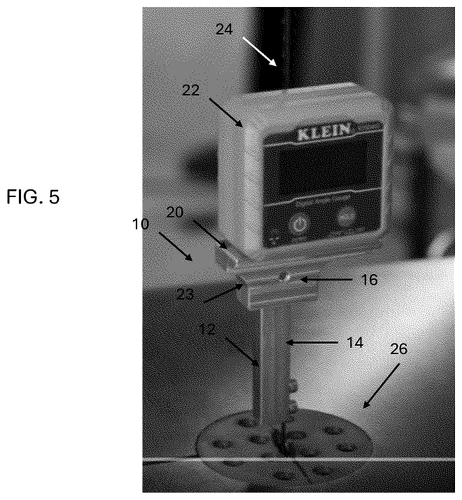

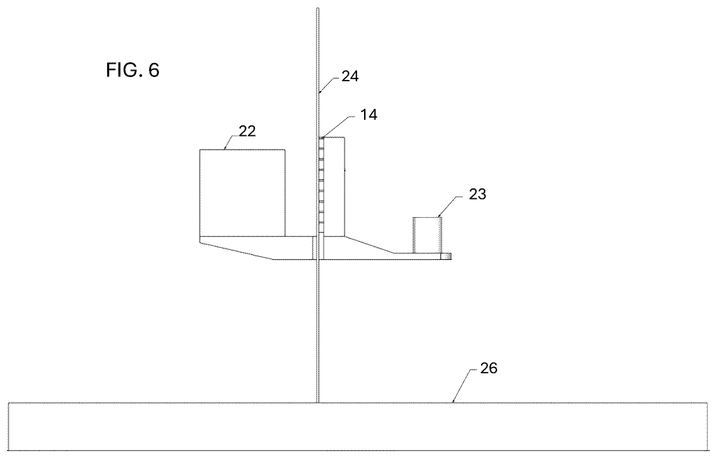

As shown in FIGS. 4-5, the tool 10 has the platform 16 secured to and/or in a front of the main body 12 with the linear array of magnets 14 exposed on a side of the main body 12 allowing the tool 12 to couple securely and directly to the bandsaw blade 24 while the blade is positioned behind the platform 16 in a manner that the digital angle gauge 22 resting on the platform 16 would abut the blade 24. The tool 10 is easily coupled to and removable from the blade 24 via manual removal.

An alternative embodiment of the tool 100 is illustrated in FIG. 5. The tool 100 similarly comprises a main body 102 that houses a linear array of shallow-depth-of-field magnets 104. Extending perpendicularly from the main body 102 is a platform 106 designed to support a digital angle gauge 108. The platform 106 is exactly at a 90-degree angle relative to the magnet reference surface 110.

On the opposite side of the platform 106, a counterweight 110 is attached to the main body 102.

In use, the tool 10, 100 is attached to the bandsaw blade 24 by aligning the magnet array 14, 104 with the surface of the blade 24. The strong magnetic force ensures a secure attachment without slipping. The digital angle gauge 22 is then placed on the platform 16, 103. Due to the precise machining of the platform 16, 103 and the alignment of the center of gravity, the weight of the gauge does not cause any deflection of the bandsaw blade 24.

This setup allows a woodworker to adjust the bandsaw table 26 until the digital angle gauge 22 reads the desired angle, ensuring the table 26 is perfectly squared to the blade 24. The tool can be easily removed by detaching the magnets 14, 104 from the blade 24 and storing it for future use.

Although the present disclosure has been described with reference to preferred embodiments, workers skilled in the art will recognize that changes may be made in form and detail without departing from the spirit and scope of the disclosure.

What is claimed

1. A tool for enabling the use of a digital angle gauge with a bandsaw blade, comprising:
a main body comprising a magnet reference surface and configured to attach securely to a bandsaw blade;
a platform extending perpendicularly from the main body at a 90-degree angle relative to the magnet reference surface and comprising a surface configured to support a digital angle gauge thereon; and
a counterweight,
wherein the counterweight is configured such that a combined center of gravity of the tool and the digital angle gauge supported thereon aligns with a plane of the bandsaw blade when the tool is used, thereby preventing deflection of the bandsaw blade under a weight of the digital angle gauge.

2. The tool of claim 1, wherein the magnet reference surface comprises an array of magnets.

3. The tool of claim 2, wherein the magnets are neodymium magnets arranged linearly along the main body to maximize magnetic engagement with thin bandsaw blades.

4. The tool of claim 1 wherein the platform extends perpendicularly from the main body at exactly a 90-degree angle.

5. The tool of claim 1, wherein the counterweight is integrated into a body of the platform.

6. The tool of claim 1, wherein the platform is supported by a platform body which is secured to the main body and wherein the counterweight is provided in or by the main body of the platform.

7. The tool of claim 1, wherein the main body and platform are constructed from lightweight, rigid materials selected from the group consisting of aluminum, magnesium, and composite alloys.

8. The tool of claim 1, wherein the counterweight is made from a dense material selected from the group consisting of steel, tungsten, and lead to achieve the necessary mass in a compact form.

9. The tool of claim 1, wherein the platform includes a non-slip surface or material to prevent the digital angle gauge from sliding during use.

10. The tool of claim 1 and further configured to be easily attachable and detachable from the bandsaw blade without the need for additional tools or clamps.

11. A method of squaring a bandsaw blade to a bandsaw table, comprising:
magnetically coupling a main body having a platform surface positioned at a 90 angle thereto, to a bandsaw blade;
positioning a digital angle gauge on the platform surface;
fine tuning an angle of the bandsaw table according to one or more readings from the digital angle gauge; and
removing the digital angle gauge and main body having the platform from the bandsaw blade.

12. The method of claim 11 and further comprising providing a counterweight with the main body having the platform and incorporating the counterweight by aligning the combined center of gravity of the main body having the platform and the digital angle gauge with a plane of the bandsaw blade.
